(19) United States
(12) Patent Application Publication
(10) Pub. No.: US 2011/0223896 A1
(43) Pub. Date: Sep. 15, 2011

(54) Meeting mode for cell phones

(76) Inventor: Allen Gerber, High Falls, NY (US)

(21) Appl. No.: 12/661,018

(22) Filed: Mar. 9, 2010

(51) Int. Cl. H04M 3/42; H04M 3/00

(52) U.S. Cl. 455/415; 455/418

(57) ABSTRACT

A cellular telephone or other portable communication device is provided with program instructions which cause the device to be set into a “meeting mode” by a user. When in this mode, callers are provided with a message indicating the meeting status. The called party is preferably then provided with the option of responding to questions from the caller by selectably activating button icons on a user interface which cause an audio transmission to the called party which is not also transmitted to the device's external speaker. The icons are labeled with such short responses such as: NO, YES, MAYBE, OKAY, MORE, LESS, TODAY, TOMORROW, and NEVER.

### TECHNICAL FIELD

The present invention is generally directed to the use and operation of cellular telephone devices, especially so-called smart phones. More particularly, the present invention is directed to the inclusion of an operational mode which is effective for the management of information transmittal when the called party is in a meeting. Even more particularly, the present invention is directed to cellular telephone operation which permits the transmission of voice signals in response to user selection based on displayed icons.

### BACKGROUND OF THE INVENTION

The need to communicate is an essential human activity. The demands of modern life in an electronic age have made such communication even more essential. This has led to increasing instances where communication is both desired and essential. The present invention is directed to improving communication within the context of one of life's most ubiquitous activities: the meeting.

Meetings are, by their very nature, established for the purpose of communication. The communication is intended to be two-way, but there are times when the flow of communication is one-way and there are also natural lulls that occur as well. However, as many have observed, the flow information exchange is severely interrupted by the receipt of a ringing cellular telephone. This problem is ameliorated by users placing their phones in “vibrate mode,” but even so, many users will still take a call during a meeting when the phone vibrates, thus indicating an incoming call. This is an activity which is disruptive of the meeting and which can often result in annoyance and resentment from the other meeting attendees.

The present invention is intended to significantly reduce the occurrence of calls that produce such an annoyance while still providing the called party an opportunity to respond in a multi-tasking fashion with a minimum of intrusion to the meeting and a minimum of embarrassment to the called party.

From the above, it is therefore seen that there exists a need in the art to overcome the deficiencies and limitations described herein and above.

### SUMMARY OF THE INVENTION

The shortcomings of the prior art are overcome and additional advantages are provided via a method for cellular telephone operation having the following steps: receiving a call on a cellular telephone from a caller and determining, that the cellular telephone is in a special mode called meeting mode. An initial audio message is then provided to the caller indicating that the cellular telephone is in meeting mode, typically by indicating that the called party is currently in a meeting. There is then provided to the caller at least one subsequent audio message selectable by an operator of the cellular telephone.

In other words, when a user of the present invention enters a meeting, or otherwise so desires, the user puts the cellular telephone device in a special mode, referred to herein as “meeting mode.” This selection by the user preferably automatically also sets the phone in vibrate mode. When a call is received, the called party is provided with a message, preferably in the voice of the called party, that says that the called party is in meeting mode. The message also preferably indicates that the caller has the option of leaving a message, listening to the meeting, or asking questions whose responses are limited. The called party's cellular device, not necessarily being limited to what is now referred to as a telephone or phone, then displays a set of icons that can be selected so as to playback indicated voice messages over the phone. For example, the icons might display simple answers such as “YES,” “NO,” “MAYBE,” “IT DEPENDS,” “NEVER,” “ALWAYS,” “TODAY,” “TOMORROW,” and “SOON.” In preferred embodiments of the present invention, these options are provided by the called party both as to the word or words on the icon and as to the audio that is played back to the calling party. In many instances, the caller opts to select to ask questions for which short answers are provided by the called party who can unobtrusively respond without using his voice in a manner which disturbs others. The caller, however, does preferably hear the selected short response in the voice of the called party. Synthesized voice responses are also provided at the option of the called party user.

It is therefore an object of the present invention to reduce interruptions that occur in the course of various meetings, including business meetings, staff meetings, club meetings and other organizational meetings

It is another object of the present invention to enable a caller to be apprised of the fact (real or faked by the called party) that the called party is in a meeting.

It is a further object of the present invention to enable a called party to respond to a caller without speaking.

It is yet another object of the present invention to expand the use of cellular and/or other portable telephone devices in an unobtrusive fashion.

It is also an object of the present invention to provide a silent communications link between a caller and a called party.

If is yet another object of the present invention to indicate that, not only is the called party in a meeting, but to provide an indication as to when the meeting is to end.

It is a still further object of the present invention to provide a called party user with a capability to customize an interface used to provide a “silent” response.

It is a further object of the present invention to provide a “silent” audio response to a caller in the voice of the called party or in an otherwise selectable voice.

It is also an object of the present invention to enable a calling party to listen to the conversation occurring during a meeting being attended by the called party.

Lastly, but not limited hereto, it is an object of the present invention to permit a called party to customize a short response interface as a function of the identity or type category of the calling party.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is an exterior view illustrating the display and controls associated with a typical smart cellular telephone device;

FIG. 2 is a block diagram illustrating the functional components found within a smart cellular telephone device employed in the present invention;

FIG. 3 is a flow chart illustrating the steps carried out as per the stored program instructions found within storage components of a typical smart cellular telephone device;

FIG. 4 represents a display screen illustrating the menu and options presented when the meeting mode application of the present invention is first entered;

FIG. 5 represents a display screen illustrating the menu and options presented during a setup mode of the present invention employed for entering category information;

FIG. 6 represents a display screen illustrating the menu and options presented during a portion of the setup mode in which responses are determined and in which audio associated with those responses is also established; and

FIG. 7 Represents a display screen illustrating the menu and options presented when the “Press to Activate” button from FIG. 4 is pressed.

### DETAILED DESCRIPTION

In one of the embodiments of the present invention, once a user sets his or her device (typically a smart cellular telephone, but not limited thereto) into a special mode referred to herein as “meeting mode,” the behavior of the device is changed to reflect the fact that the user is in a meeting. It is noted though that there may be other circumstances in which the user selects “meeting mode” other than actually being in a meeting. In particular, there are situations in which a called party may simply wish to provide the caller with short answer responses even if the called party is not in a meeting. In short, references herein to “meeting mode” should not be construed as actually requiring that a meeting is taking place.

Once the user has selected “meeting mode” and a call is received, the called party is provided with an audio message indicating a status that is preselected by the user. Typically, the audio message indicates the status as being that the called party/user is in a meeting. Other status messages are also provided at the option of the user who is provided with options for customization. In a typical situation the message indicates that the called party is in a meeting. The message further indicates that the caller has the opportunity, if needed or desired, to ask questions having short answers. These answers are provided by the called party by his or her pressing an icon on a screen which is displayed to the user upon the receipt of a call when the device is in meeting mode.

Pressing such an icon transmits audio information to the caller. This audio information may be of several kinds. In a first embodiment, the audio corresponds to words on the icons spoken in the voice of the user. This audio is provided to the device during a customization phase of operation under the control of the user. In a second embodiment, the transmitted audio is in a prerecorded voice provide with an installation of the program instructions used to implement the practice of the various embodiments of the present invention. In a third embodiment, the audio provided in response to the selection of an on-screen icon is a synthesized voice provided by an on-board voice synthesizer which responds to an input which is derived from the text shown on the icon. For example, if the icon is labeled “NO,” the synthesizer creates an audible human representation of the spoken word “NO” and the resulting audio representation is transmitted to the caller.

In a first phase of use of this invention, the user is presented with options for customization. In particular, after installation, typically via a wireless download, the user is given the option of which one of the three voice response modalities the user wishes to employ. The user is also provided with the opportunity to select from a set of caller categories such as “Business,” “Family,” “Bridge Club,” “Church” and the like. Some of these categories are provided at time of installation. Other categories are definable by the user during the customization process. When a call is received, a caller-id functionality discerns the calling number and selects the appropriate category as predetermined by the user. As each new call is received, a user is provided with the opportunity to associate the telephone number of the incoming call with one of the above categories.

Based on the category associated with the calling party, if any, a screen displaying various response options is presented to the user. For example, a “Family” screen might include such options as icons reading “HOLD DINNER,” “EARLY TO BED,” “WILL PICK UP CHILD,” “OUR SECRET MESSAGE,” “PICK UP LAUNDRY,” “PLEASE STOP AT DRUG STORE,” and “PLEASE SOP AT BANK.” On the other hand, if the caller is identified by the device, or by the user, as being a business caller, the screen displayed to the user includes icons labeled, for example, as “NO,” “SCHEDULE IT TODAY,” “SCHDULE IT TOMORROW,” “CANCEL,” “YES,” “PAY IT,” “I'LL CALL,” etc. Some of these options are provided with an initial installation of program instructions that drive the operation of the device. Other icon options are supplied by the user during the customization phase. The user is also provided with the option of deleting and/or modifying any of the supplied choices. Some of these choices may even be employed by the user to engage in the exchange of short coded messages especially via predefined code words.

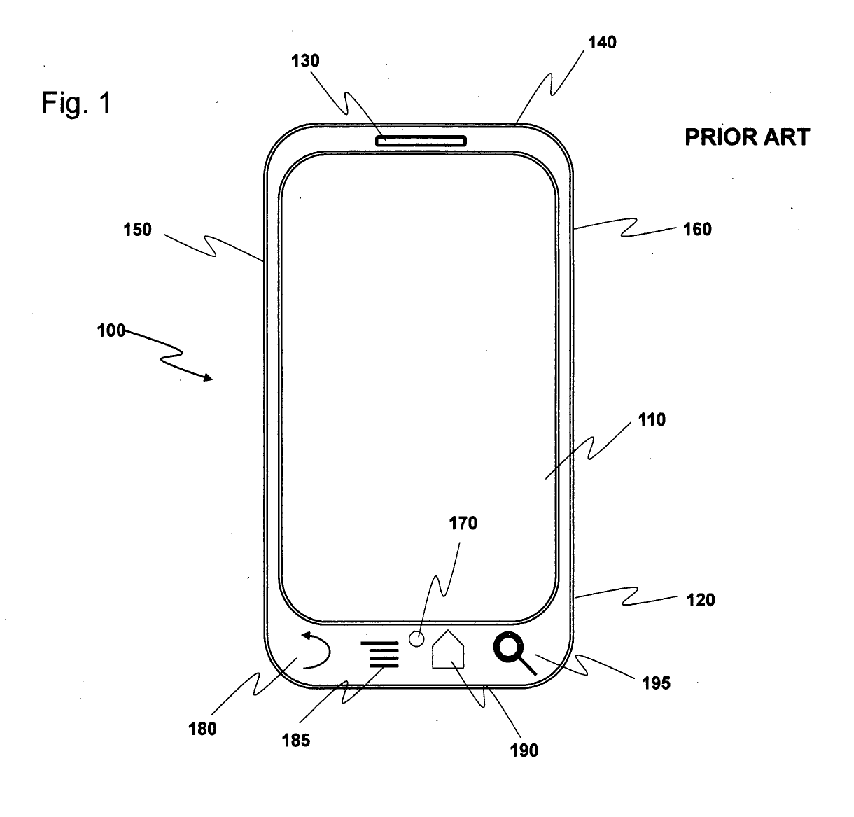

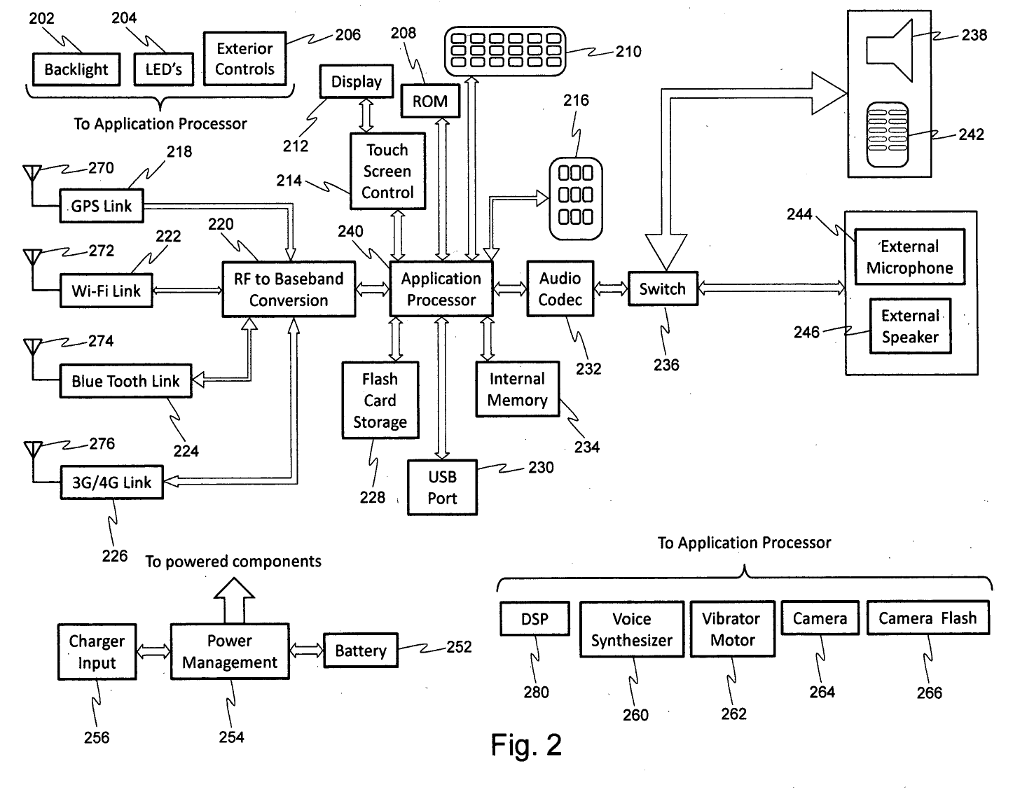

FIG. 1 illustrates the basic structure and functionality associated with a recently marketed smart cellular telephone device 100. Most importantly for the present invention, this device includes touch screen 110/display 212 (see FIG. 2). This screen forms a significant portion of body 120 of the device. The device also includes USB port 150 (not otherwise visible) through which the device may be both charged and accessed. Device 100 also incorporates side rocker switches 160 (not otherwise visible) used to control the volume of speaker 130 (also illustrated by reference numeral 238 in FIG. 2). Naturally, device 100 also includes microphone 170 (also illustrated by reference numeral 242 in FIG. 2.) Device 100 also includes jack 140 (not otherwise visible) into which external ear phones may be plugged. Device 100 also includes buttons or otherwise a touch sensitive area below the display screen 110. These buttons include “Back” button 180, “Menu” button 185, “Home” button 190 and “Search” button 195.

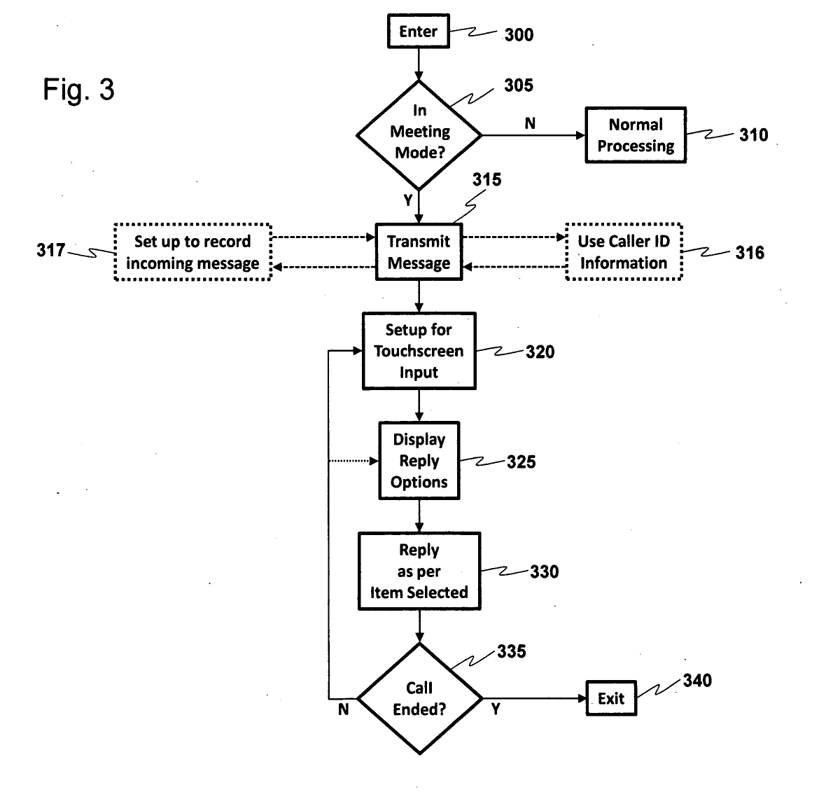

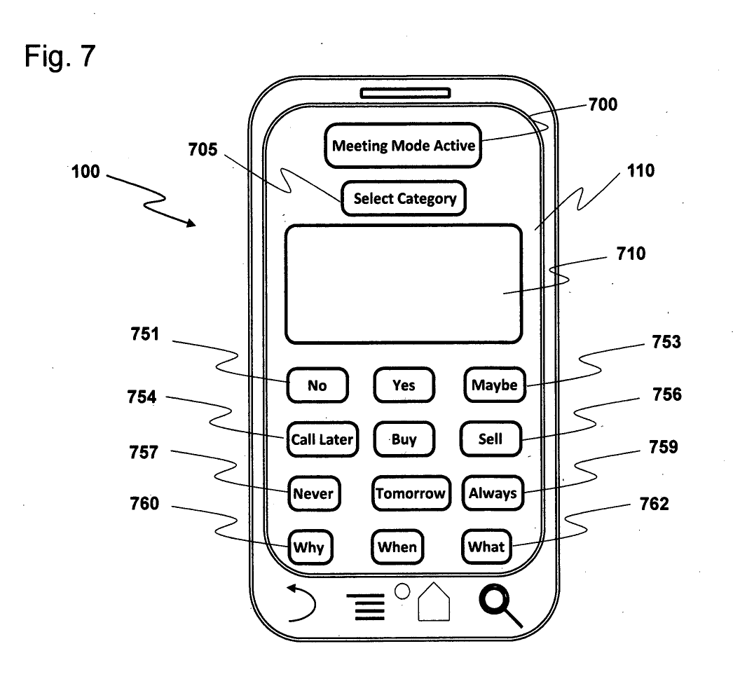

FIG. 3 is a block diagram which represents the basic functioning of the present invention as provided by program instructions stored in the memory components illustrated in FIG. 2. The operation of the present invention begins with “Enter” step 300. When a call is received, it is first determined by the programming described herein, whether or not device 100 is in “Meeting Mode” (as that term is described and intended herein). If the device is not in meeting mode normal processing occurs as shown in step 310. However, if device 100 is in meeting mode, the display screen presented to a user has the same essential appearance as that shown in FIG. 7 which illustrates the operation of the present invention after categories and responses have been selected.

At this point, an audio message is transmitted (step 315) to the caller. As described above, the audio message is either one that has been free recorded in the voice of the user or one that is produced by voice synthesizer 260 in FIG. 2. This audio is intended to be heard by the caller and provides an indication to the caller that the called party is in a meeting (or is otherwise occupied). This audio message also preferably indicates to the calling party that the calling party has the option of remaining on the line and communicating in a manner which is amenable to the transmission of short responses selected from a predetermined response set. Also, as indicated in FIG. 3, there is also optional step 316 in which Caller ID information is accessed and is used to determine the category associated with the caller. For example, if the incoming call is from a known family member, a category of “Personal” would typically be selected. As indicated above such categories typically include such items as: “Personal,” “Business” and “Other.” However as indicated above and described below, these categories are fully customizable. Also illustrated in FIG. 3 is optional step 317 in which a calling party is provided with an opportunity to leave a message. This functionality may be provided by the present invention or may be provided alternatively by a programming call to the routines associated with device 104 handling voice messages.

It is noted that there have been adopted standard tones indicating that a called line is busy. Other tones exist as well. The present invention is compatible and can be used to provide other transmitted tones. Such a tone is usable to indicate that the user is in a meeting but is otherwise near to the cell phone. The present invention therefore is seen as paving the way for a variety of programmed tones to be provided to a called party, some or all of which are adaptable as universal standards.

At this point, programming stored in the memory elements shown in FIG. 2 readies the device and its display screen for input (step 320). Based upon the selected category, the operation of the present invention causes the display on screen 110, of the set of responses selected during a setup phase of operation described more fully below (step 325). At this point, a typical display screen of the present invention would have the appearance illustrated in FIG. 7. In preferred embodiments of the present invention the set of response options appear as selectable icons on display screen 110. As for operations carried out during a setup phase, each of these responses is associated with predetermined audio material. In preferred embodiments of the present invention, this audio material constitutes recordings of the device owner/user. Based upon audio information provided over the connection from the calling party, the device user touch selects one of the icons shown in FIG. 7. This action triggers the transmission of an associated and predetermined message (step 330). The programming of the present invention then determines whether or not the call has ended and if so it exits normally (step 340). If the call has not ended, control returns back to step 320 or to step 325, as desired.

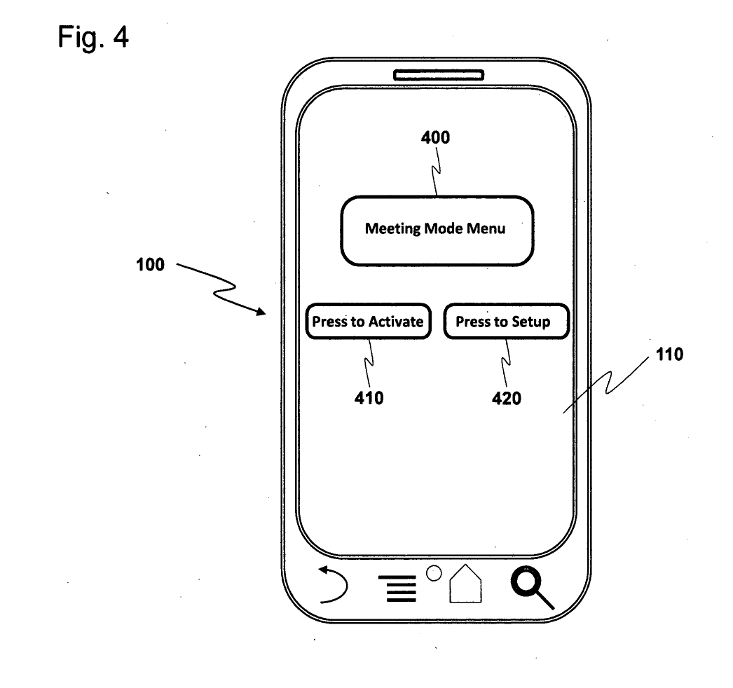

When the “Meeting Mode” application icon shown on display screen 110 is pressed or otherwise selected, a screen configuration such as that shown in FIG. 4 is displayed. In particular, there is shown label field 400 which indicates that device 100 is now in a “meeting mode selection” state and that the user may select to activate “Meeting Mode” by pressing illustrated icon 410 or the user may select to enter a “setup mode state” for the application by pressing displayed icon 420. Pressing icon 410 results in a display substantially equivalent to that shown in FIG. 4.

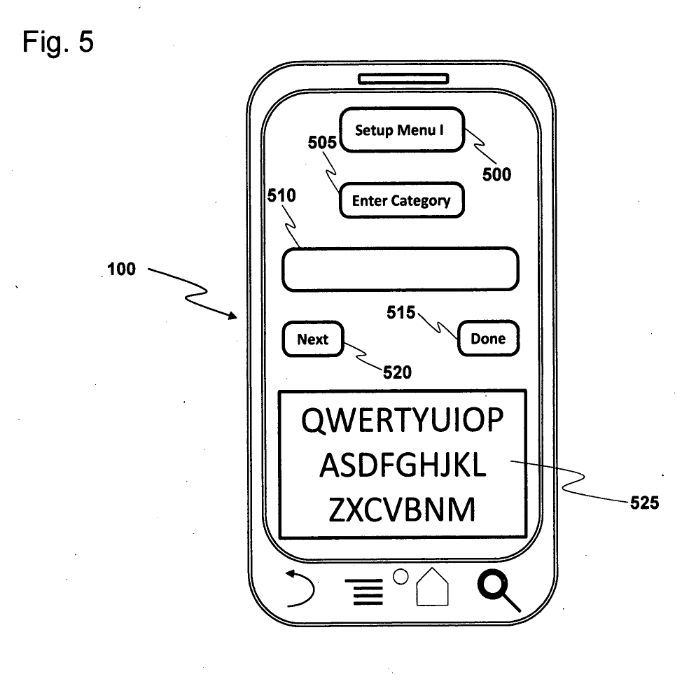

However, if the user presses displayed icon 420, a display screen such as that shown in FIG. 5 is shown to the user. This is the first of two set up menu screens available to the user. This first menu screen provides the user with the capability of entering one or more categories. Again, it is noted that one or more categories are associated with different sets of predetermined responses. These categories may be labeled “Personal,” “Business,” or “Other,” as desired by the user. It is noted however that in preferred environments the present invention, there is always at least one default “category” labeled “First Response.” This category is thus usually associated with a recording of the user's voice providing a message to the calling party such as: “I am in a meeting right now but can provide short answers invoice form from a predetermined, limited set of responses. If you don't wish to continue, please hang up now. If you wish to continue please proceed with an appropriately limited question. If you wish to leave a message please let me know now and I will transfer you to a voice recording function.”

With respect to the embodiment shown in FIG. 4, it is noted that there is at least one alternative in which activation and set up icons are separately displayed on screen 110. In particular, in this embodiment separate icons for setup and activation are already provided on the main screen display. This embodiment is particularly useful in that, merely by pressing a single icon, the device is immediately placed in “meeting mode.” This provides a fast path to this status.

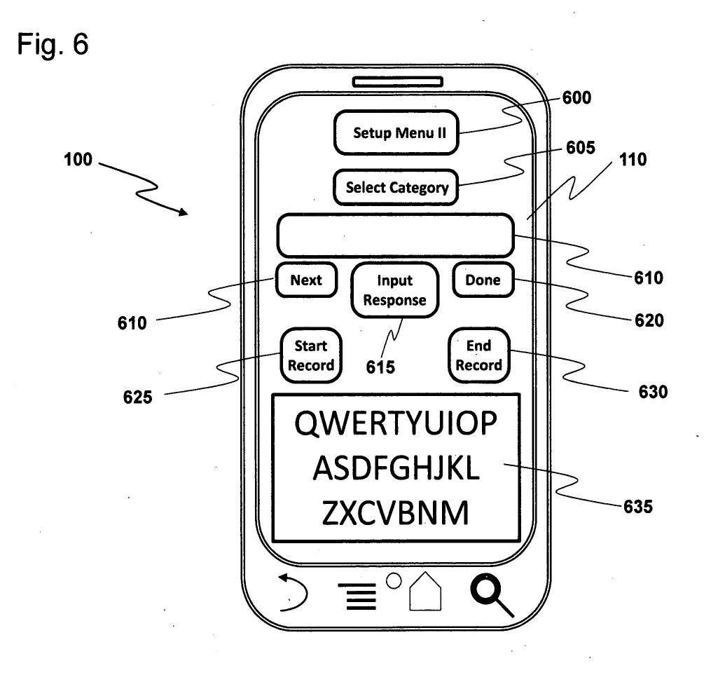

FIG. 5 illustrates the first of two setup screens for applications consistent with the operation of present invention. Accordingly, this purpose is set forth in display label 500 and likewise in display label 505 instructs the user to enter category information in box 510. This is done by means of displayed keyboard 525. Alternatively in those devices in which a “real” keyboard is provided, input is also accepted from that device. When the user is through entering a category in box 510, the user presses icon 520 (Next) to enter a next category. When all of the categories desired by the user are entered, pressing icon 515 (Done) in order to transfer control to a second phase of setup information. It is noted that, in typical embodiments of the present invention, once all of the desired category information is supplied, setup functionality illustrated in FIG. 5 is simply bypassed by the user's first pressing “Done” icon 515. This results in an immediate transfer to a setup state such as that illustrated in FIG. 6.

FIG. 6 illustrates a second of two setup screens for the running of applications consistent with the operation of the present invention. As above, setup status is indicated by displayed label 600 (Setup Menu II), indicating that this is the second of two setup menus. A second displayed label 605 (Select Category), then instructs the user to select a category. A list of possible categories is displayed in window 610 in either a horizontal or vertical scrolling fashion. Once a desired category is displayed, the user presses icon 620 (Done) to move to the next stage of operation. The user then presses icon 615 (Input Response) and uses displayed keyboard 635 to enter response information into window 610. The user then presses “Start Record” icon 625 and records an audio version of the typed text, after which “End Record” button 630 is pressed. For example, a user might type “Call back” into window 610 and then record an audio version of the exact same textual material. The present application and thereafter associates the pressing of a button labeled “Call back” with the recorded material which is subsequently played back to the calling party when the appropriate button is pressed. At this point, when a user presses the “Done” icon, setup is complete.

When meeting mode is activated in a device of the present invention, a screen such as that shown in FIG. 7 is displayed. Unless there is a default category selected, a user is provided with an opportunity to select a category for a response set. Once a category is selected, a plurality of icons is displayed below window 710 in accordance with the previously provided responses (second phase of setup; see FIG. 6). At this point, pressing of icons such as those shown in FIG. 7 (reference numerals 751-762), causes corresponding audio signals to be transmitted to a calling party. In this way, a person who was attending a meeting and using a device in accordance with the present invention is able to answer his or her telephone and to carry on a conversation with the calling party with minimal disruptions to the meeting taking place. This is particularly true if users also take advantage of wireless Bluetooth technology.

FIG. 2 is a functional block diagram of a cellular telephone employable in conjunction with the present invention. In particular, the program instructions for carrying out the operations of the present invention are typically stored in internal memory 234 during invention utilization. These program instruction steps may also be encoded and stored in flash card storage 228. Both of these storage units are connected to application processor 240. It is additionally noted that instructions for the present invention may also be predisposed in read-only memory 208. In preferred embodiments of the present invention, the meeting mode application is initiated via touching an icon shown on display 212 (which it should be understood to be synonymous with display screen 110 referenced above). Touchscreen control 214 signals this event to processor 240. When processor 240 receives an indication from the baseband conversion unit 220 that an incoming call is present, program instructions in accordance with the present invention retrieve digitally stored voice information from any one of the three possible storage modalities (228, 234 and 208). This data is interpreted as audio information and is transmitted to baseband conversion unit 224 transmission over the currently selected connection pathway. This pathway comprises one of three links, WiFi link 222, Bluetooth link 224 or 3G/4G link 226. Each of these pathways includes a link to a corresponding antenna illustrated as 272, 274 and 276, respectively. In most cases, it is the 3G/4G link 226 that is employed.

In typical operation, the program instructions associated with the present invention further operate to display response options on display 212. These are options that have been previously stored in one or more of the device's storage units. The program instructions then set the unit in a state in which it is prepared to accept input from display 212 and to associate that input with previously recorded audio information provided by the user and again, stored in one or more of the device's storage units. Upon receipt of a selected signal from display 212, program instructions cause the retrieval of an associated digitally recorded audio response to be sent out to the calling party the transmission of the audio signal to baseband conversion unit 220.

In one mode of operation for the present invention, program instructions, retrieved from one or more of the unit's storage devices, retrieve information pertaining to the identity of the calling party. The program instructions then operate to select from one or more predetermined screens, as described above. Typically these screens are associated with categories such as “Business,” “Personal,” “Family,” and/or “Other.” Based upon the identity of the calling party various screens are displayable. As indicated above, the entries on these screens are determinable by the end user. In any case, the program instructions associated with the present invention, as described above, cause the receiving device to be put into a state in which it is ready to receive input from display 212 typically via the operators touching one of the displayed icons. Selection of a display screen may also be controlled in dependence upon location information is provided through GPS link 218 and its associated antenna 270. It is also noted that user input may be supplied via keyboard 210 or keypad 216. Keyboard 210 may be an included hardware defined keyboard or may be implemented as a displayed keyboard shown on touchscreen display 212.

As indicated above, program instructions associated with the use of the present invention also include a mode of operation in which categories, screens and individualized responses are established. This mode of operation is entered, for example, by pressing icon 420 shown in FIG. 4. Once in this mode of operation, a user is prompted to input audio information. This information is provided either through internal microphone 242 or external microphone 244. Which is used depends upon whether or not an external headphone type of device is plugged into the unit. Such units also include an external speaker 246 and an internal speaker 238. The connection is determined by switch 236 which is typically activated by the insertion of a jack attached to an external headphone. Having selected the setup mode of operation, program instructions associated with the present invention except audio information coming through switch 236 and codec 232 and store this information in one of the device's storage units. It is noted that digital signal processor 280 is also employable to convert the audio signal to a digital representation which is more readily storable and perhaps even compressed.

At this point, program instructions associated with the present invention also set the device in a state which is capable of accepting input from keyboard 210 and storing this information so as to associate it with the audio input described above. Though unlikely, such information may also be provided from keypad 216 in the event that it is only necessary to transmit predetermined numerical information. Information provided from either keyboard 210 or keypad 216 is stored so as to be displayable on icons present on the various screens described above. It is noted that the linking of audio and alphanumeric information established during setup persists during normal invention operation. For example, an audio input provided during setup that recites “Close the deal” becomes quasi-permanently associated with an icon that also displays this text. It is, however, noted that the present invention does not require the text displayed on a screen to contain the same information as conveyed via audio. In particular, is noted that, in the example cited, the icon on display 212 might only display the text: “CLOSE.”

In one embodiment of the present invention, audio information is not stored, but rather what is stored is textual information which is converted to audio voice information via voice synthesizer 260. In this mode of operation, what has been previously described as stored audio information is present as stored alphanumeric information which is converted via synthesizer 260 for transmission over one of the links indicated above.

For completeness, it is noted that devices preferably employed in the present invention also typically include vibrator motor 262 for providing silent signals to the user. In such “smart phones” there is also included camera 264 and camera flash 266. These photographic capabilities are employable in conjunction with the present invention in that they provide a mechanism for capturing images of a caller and for displaying that image upon associating that caller with an incoming telephone number and corresponding image as captured by camera 264 at some previous time.

It is also noted that devices preferably employed in the present invention also typically include backlight 202 for display 212. There may also be provided exterior indicators that provide information via lights such as LED indicators 204. The device typically also includes such exterior controls as is illustrated in FIG. 1 (see reference numerals 160, 180, 185, 190, and 195 in FIG. 1). Also present in devices preferably employed in the present invention, there is found battery 252 and charger input 256. Power management component 254 often controlled by processor 240 supplies power to the various component's shown in FIG. 2.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. A method for cellular telephone operation, said method comprising the steps of:
receiving a call on said cellular telephone from a caller;
determining that said cellular telephone is in meeting mode;
providing an initial audio message to said caller indicating that said cellular telephone is in meeting mode; and
providing to said caller at least one subsequent audio message selectable by an operator of said cellular telephone.

2. The method of claim 1 in which said subsequent audio message is selectable, by said operator, from a displayed list.

3. The method of claim 1 which, after said receiving step and before said step of providing said subsequent audio message, further including the steps of:
identifying said caller; and
displaying a menu of selectable subsequent audio messages.

4. The method of claim 3 in which said menu is determined as a function of the identification of said caller.

5. The method of claim 1 in which said initial audio message is in the voice of said operator.

6. The method of claim 1 in which said subsequent audio message is in the voice of said operator.

7. The method of claim 2 in which said displayed list is a set of buttons labeled with at least one indicium selected from the set consisting of YES, NO, MAYBE, NEVER, IT DEPENDS, LATER, TODAY, OKAY, MORE, LESS, TOMORROW, and SAY AGAIN.

8. The method of claim 7 in which said subsequent audio message matches said selected labeled button.

9. A programmable cellular telephone having storage therein for carrying out program instructions contained in said memory for: receiving a call on said cellular telephone from a caller; determining that said cellular telephone is in meeting mode; providing an initial audio message to said caller indicating that said cellular telephone is in meeting mode; and providing to said caller at least one subsequent audio message selectable by an operator of said cellular telephone.
